(19) United States
(12) Patent Application Publication
(10) Pub. No.: US 2022/0107288 A1
(43) Pub. Date: Apr. 7, 2022

(54) GAS SENSOR

(71) Applicant: NGK Insulators, Ltd., Nagoya-shi (JP)

(72) Inventors: Soichiro YOSHIDA, Nagoya-shi (JP); Kosuke UJIHARA, Nagoya-shi (JP)

(21) Appl. No.: 17/487,009

(22) Filed: Sep. 28, 2021

(30) Foreign Application Priority Data
Oct. 2, 2020 (JP) 2020-167843

(51) Int. Cl. G01N 27/41; G01N 27/409; G01N 27/419

(52) U.S. Cl. CPC G01N 27/41; G01N 27/419; G01N 27/409

(57) ABSTRACT

The gas sensor is configured to measure a concentration of a predetermined gas component. The gas sensor includes a sensor element. An internal cavity configured to introduce the measurement target gas from an external space is formed inside the sensor element. The sensor element has a long side and a short side in a plan view. In the sensor element, a proportion of a length in the short side direction of a portion that is shortest in the short side direction, out of portions in which the internal cavity is not formed, to the length of the short side is 0.22 or more. The sensor element has an upper face and a lower face. A proportion of a length from the end portion of the internal cavity near the lower face to the lower face, to a thickness of the sensor element, is 0.50 or more and 0.65 or less.

### CROSS-REFERENCE TO RELATED APPLICATION

The present application claims priority from Japanese application JP 2020-167843, filed on Oct. 2, 2020, the contents of which is hereby incorporated by reference into this application.

### TECHNICAL FIELD

The present invention relates to a gas sensor, and particularly relates to a gas sensor configured to measure the concentration of a predetermined gas component in a measurement target gas.

### BACKGROUND ART

Japanese Patent No. 3860590 discloses a gas sensor. This gas sensor is configured to measure the NOx concentration in a measurement target gas. This gas sensor includes a sensor element, and a main component of the sensor element is an oxygen ion-conductive solid electrolyte.

In this sensor element, a first cavity configured to introduce a measurement target gas from the external space and a second cavity connected to the first cavity are formed. A detection electrode for use in measurement of the NOx concentration is formed inside the second cavity. In the gas sensor, the oxygen concentration in the first cavity is adjusted by a main pump cell including an internal pump electrode formed inside the first cavity and an external pump electrode formed outside the first cavity.

That is to say, in this gas sensor, a measurement target gas whose oxygen partial pressure is kept low is supplied to the detection electrode, and the NOx concentration is measured based on the measurement target gas (see Japanese Patent No. 3860590).

Japanese Patent No. 3860590 is an example of related art.

Gas sensors are attached to, for example, an exhaust pipe of an engine. Recently, it is required to start such a gas sensor soon after an engine is started. That is to say, it is required to bring forward the time to increase the temperature of a sensor element, and to rapidly increase the temperature of the sensor element, after an engine is started.

Condensate water may be present in an exhaust pipe immediately after an engine is started. If the time to increase the temperature of a sensor element after an engine is started is brought forward, condensate water may be attached to the sensor element with an increased temperature. For example, if the time to increase the temperature of the sensor element in the gas sensor disclosed in Japanese Patent No. 3860590 above is brought forward, thermal stress generated by attachment of condensate water to the sensor element may cause a crack in the sensor element.

Furthermore, for example, if the temperature of the sensor element in the gas sensor disclosed in Japanese Patent No. 3860590 above is rapidly increased, thermal stress resulting from a prompt increase in the temperature may cause a crack in the sensor element.

### SUMMARY OF THE INVENTION

The present invention was made in order to solve the above-described problems, and it is an object thereof to provide a gas sensor in which a sensor element is unlikely to crack even when the gas sensor is started soon after an engine is started.

The gas sensor according to the present invention is configured to measure a concentration of a predetermined gas component in a measurement target gas. The gas sensor includes a sensor element. A main component of the sensor element is an oxygen ion-conductive solid electrolyte. An internal cavity configured to introduce the measurement target gas from an external space is formed inside the sensor element. The sensor element includes an oxygen pumping cell. The oxygen pumping cell includes an internal pump electrode and an external pump electrode. The internal pump electrode is formed inside the internal cavity. The external pump electrode is formed in a space different from the internal cavity. The oxygen pumping cell is configured to pump out oxygen in the internal cavity, by applying a voltage to a point between the internal pump electrode and the external pump electrode. The sensor element has a long side and a short side in a plan view. A proportion of a length in the short side direction of the internal cavity to a length of the short side is 0.40 or more and 0.55 or less. The sensor element has an upper face and a lower face. A proportion of a length from the end portion of the internal cavity near the lower face to the lower face, to a thickness of the sensor element, is 0.50 or more and 0.65 or less.

The inventor(s) of the present invention focused on the fact that a crack in sensor elements occurs mainly from the internal cavity. Thus, the inventor(s) of the present invention found that a crack in a sensor element particularly resulting from a prompt increase in the temperature can be suppressed by ensuring to some extent a length of a portion that is shortest in the short side direction out of portions in which the internal cavity is not formed. In the gas sensor according to the present invention, a proportion of a length in the short side direction of a portion that is shortest in the short side direction, out of portions in which the internal cavity is not formed, to a length of the short side is 0.22 or more. Thus, according to this gas sensor, since the length in the short side direction of the portion that is shortest in the short side direction, out of portions in which the internal cavity is not formed, is long to some extent, a crack in the sensor element resulting from a prompt increase in the temperature can be suppressed.

Furthermore, the inventor(s) of the present invention found that a crack in a sensor element particularly resulting from attachment of condensate water can be suppressed by arranging the position of the internal cavity close to the center in the thickness direction of the sensor element. In the gas sensor according to the present invention, a proportion of a length from the end portion of the internal cavity near the lower face to the lower face, to a thickness of the sensor element, is 0.50 or more and 0.65 or less. Thus, according to this gas sensor, since the position of the internal cavity is close to the center to some extent in the thickness direction of the sensor element, a crack in the sensor element resulting from attachment of condensate water can be suppressed. Thus, according to the present invention, it is possible to provide a gas sensor in which a sensor element is unlikely to crack even when the gas sensor is started soon after an engine is started.

In the gas sensor, a proportion of the length in the short side direction of the internal cavity to the length of the short side of the sensor element may be 0.40 or more and 0.55 or less.

The inventor(s) of the present invention found that a crack in a sensor element particularly resulting from a prompt increase in the temperature can be suppressed by making the length in the short side direction of the internal cavity short. A proportion of the length in the short side direction of the internal cavity to the length of the short side is 0.40 or more and 0.55 or less. Thus, according to this gas sensor, since the length in the short side direction of the internal cavity is short to some extent, a crack in the sensor element resulting from a prompt increase in the temperature can be suppressed.

In the gas sensor, the sensor element may further include a heat generating unit configured to generate heat, and the heat generating unit may be arranged closer to the lower face than to the upper face in the thickness direction of the sensor element.

Furthermore, in the gas sensor, a diffusion control unit may be further formed inside the sensor element, the diffusion control unit may be configured to apply a predetermined diffusion resistance to the measurement target gas introduced from the external space via a gas introduction opening, the diffusion control unit may include a hole that extends in the long side direction and connects the gas introduction opening and the internal cavity, and a proportion of a length in the short side direction of the hole to a length in the thickness direction of the hole may be 0.50 or more and 30.00 or less.

Furthermore, in the gas sensor, the diffusion control unit may include a first diffusion control unit and a second diffusion control unit, the first and second diffusion control units may be arranged along the long side direction, and a cross-sectional shape in the thickness direction of the first diffusion control unit and a cross-sectional shape in the thickness direction of the second diffusion control unit may be different from each other.

Furthermore, in the gas sensor, one of the first and second diffusion control units may include the hole, and the other of the first and second diffusion control units may include two slits that are arranged along the thickness direction.

According to this gas sensor, since one of the first and second diffusion control units includes the hole, the rigidity of the sensor element can be increased, and, furthermore, since the other of the first and second diffusion control units includes two slits that are arranged along the thickness direction, a decrease in the precision of measurement regarding a predetermined gas component, resulting from a pulsation of the exhaust pressure, can be suppressed. That is to say, according to this gas sensor, it is possible to increase the rigidity of the sensor element, and also to suppress a decrease in the precision of measurement regarding a predetermined gas component.

Furthermore, in the gas sensor, the sensor element may be a stack of a plurality of ceramic layers, the external pump electrode may be covered by any one of the plurality of ceramic layers in the sensor element, and a slit portion that is continuous with the external space may be formed between the ceramic layer covering the external pump electrode and the external pump electrode.

According to this gas sensor, since the external pump electrode is covered by a ceramic layer, ingress of liquid onto the external pump electrode can be suppressed, and, furthermore, since a slit portion is formed between the ceramic layer and the external pump electrode, oxygen can be efficiently discharged from the external pump electrode to the external space.

According to the present invention, it is possible to provide a gas sensor in which a sensor element is unlikely to crack even when the gas sensor is started soon after an engine is started.

### BRIEF DESCRIPTION OF THE DRAWINGS

FIG. 1 is a cross-sectional schematic view schematically showing an example of the configuration of a gas sensor.

FIG. 2 is a graph showing an example of the way the temperatures of a sensor element and the like change.

FIG. 3 is a view including a schematic view showing part of a cross-section of the gas sensor according to an embodiment and a schematic view showing part of a cross-section of a comparative gas sensor.

FIG. 4 is a view including a schematic view showing part of a plane of the gas sensor according to the embodiment and a schematic view showing part of a plane of the comparative gas sensor.

FIG. 5 is a view schematically showing part of a cross-section taken along V-V in FIG. 4.

FIG. 6 is a view schematically showing part of a cross-section taken along VI-VI in FIG. 4.

FIG. 7 is a cross-sectional schematic view schematically showing an example of the configuration of a gas sensor including a sensor element with a three-cavity structure.

FIG. 8 is a view schematically showing part of a cross-section in a thickness direction of a sensor element according to a modified example.

FIG. 9 is a view showing part of a plane of a gas sensor according to a modified example.

FIG. 10 is a view showing part of a plane of another gas sensor according to a modified example.

FIG. 11 is a view schematically showing an apparatus for use in a water ingress resistance test.

FIG. 12 is a graph showing an example of a change in a heater resistance.

FIG. 13 is a graph showing results of a water ingress resistance test.

FIG. 14 is a graph showing results of a rapid temperature increase test.

### EMBODIMENTS OF THE INVENTION

Hereinafter, an embodiment of the present invention will be described in detail with reference to the drawings. Note that the same or corresponding constituent elements in the drawings are denoted by the same reference numerals and a description thereof will not be repeated.

### 1. Schematic Configuration of Gas Sensor

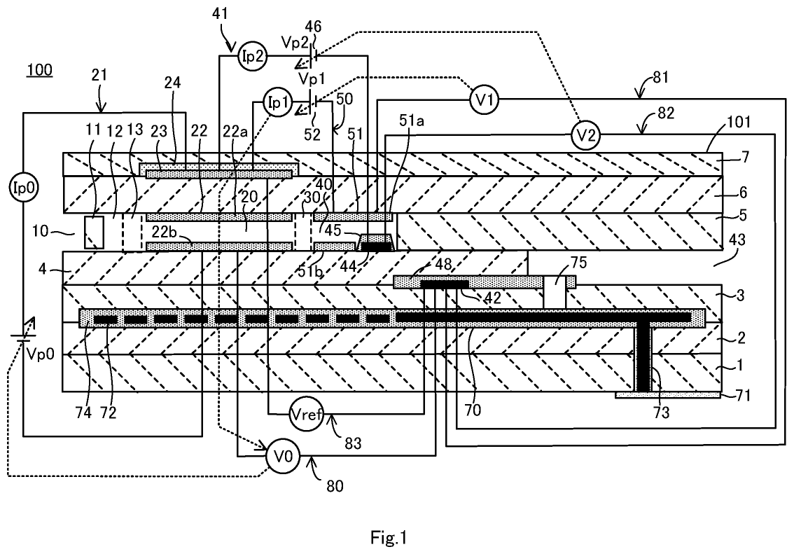

FIG. 1 is a cross-sectional schematic view schematically showing an example of the configuration of a gas sensor 100. A sensor element 101 is an element having a structure in which seven layers consisting of a first substrate layer 1, a second substrate layer 2, a third substrate layer 3, a first solid electrolyte layer 4, a spacer layer 5, a second solid electrolyte layer 6, and an upper portion layer 7 are stacked in this order from the lower side in the drawing, the layers being each constituted by an oxygen ion-conductive solid electrolyte layer made of zirconia (ZrO₂) or the like. Furthermore, the solid electrolyte forming these seven layers is a dense and airtight material. The sensor element 101 with this configuration is produced, for example, by performing predetermined processing and printing of wiring patterns on ceramic green sheets corresponding to the respective layers, stacking the resultant layers, and integrating them through firing. The sensor element 101 is, for example, a stack of a plurality of ceramic layers.

In the front end portion of the sensor element 101, a gas introduction opening 10, a first diffusion control unit 11, a buffer space 12, a second diffusion control unit 13, a first internal cavity 20, a third diffusion control unit 30, and a second internal cavity 40 are arranged in this order adjacent to each other in a connected manner between the lower face of the second solid electrolyte layer 6 and the upper face of the first solid electrolyte layer 4.

The gas introduction opening 10, the buffer space 12, the first internal cavity 20, and the second internal cavity 40 are spaces inside the sensor element 101, the spaces being each formed by cutting out the spacer layer 5, and each having an upper portion defined by the lower face of the second solid electrolyte layer 6, a lower portion defined by the upper face of the first solid electrolyte layer 4, and side portions defined by the side faces of the spacer layer 5.

The first diffusion control unit 11 is provided as two laterally long slits (whose openings have the long side direction perpendicular to the section of the diagram). Furthermore, the second diffusion control unit 13 and the third diffusion control unit 30 are each provided as a hole whose length in the direction perpendicular to the section of the diagram is shorter than that of the first internal cavity 20 and the second internal cavity 40. The second diffusion control unit 13 and the third diffusion control unit 30 will be described later in detail. Note that the region from the gas introduction opening 10 to the second internal cavity 40 is also referred to as a gas flow passage.

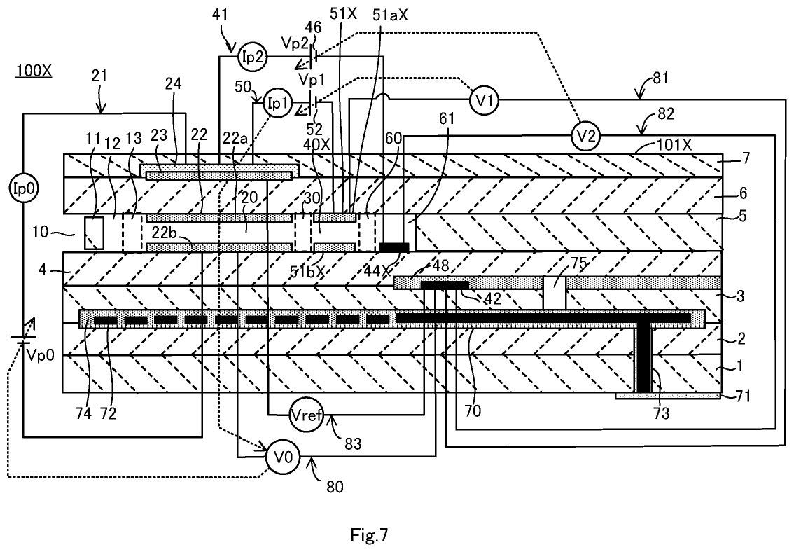

Furthermore, a reference gas introduction space 43 having side portions defined by the side faces of the first solid electrolyte layer 4 is provided between the upper face of the third substrate layer 3 and the lower face of the spacer layer 5, at a position that is farther from the front side than the gas flow passage is. For example, air is introduced into the reference gas introduction space 43. It is also possible that the first solid electrolyte layer 4 extends to the rear end of the sensor element 101, and the reference gas introduction space 43 is not formed. Furthermore, if the reference gas introduction space 43 is not formed, an air introduction layer 48 may extend to the rear end of the sensor element 101 (see FIG. 7, for example).

The air introduction layer 48 is a layer made of porous alumina, and reference gas is introduced into the air introduction layer 48 via the reference gas introduction space 43. Furthermore, the air introduction layer 48 is formed so as to cover a reference electrode 42.

The reference electrode 42 is an electrode formed so as to be held between the upper face of the third substrate layer 3 and the first solid electrolyte layer 4, and, as described above, is covered by the air introduction layer 48 that is continuous with the reference gas introduction space 43. Furthermore, as will be described later, it is possible to measure the oxygen concentration (oxygen partial pressure) in the first internal cavity 20 or the second internal cavity 40, using the reference electrode 42.

In the gas flow passage, the gas introduction opening 10 is a region that is open to the external space, and a measurement target gas is introduced from the external space via the gas introduction opening 10 into the sensor element 101.

The first diffusion control unit 11 is a region that applies a predetermined diffusion resistance to the measurement target gas introduced from the gas introduction opening 10.

The buffer space 12 is a space that is provided in order to guide the measurement target gas introduced from the first diffusion control unit 11 to the second diffusion control unit 13.

The second diffusion control unit 13 is a region that applies a predetermined diffusion resistance to the measurement target gas introduced from the buffer space 12 into the first internal cavity 20.

When the measurement target gas is introduced from the outside of the sensor element 101 into the first internal cavity 20, the measurement target gas abruptly introduced from the gas introduction opening 10 into the sensor element 101 due to a change in the pressure of the measurement target gas in the external space (a pulsation of the exhaust pressure in the case in which the measurement target gas is exhaust gas of an automobile) is not directly introduced into the first internal cavity 20, but is introduced into the first internal cavity 20 after passing through the first diffusion control unit 11, the buffer space 12, and the second diffusion control unit 13 where a change in the concentration of the measurement target gas is canceled. Accordingly, a change in the concentration of the measurement target gas introduced into the first internal cavity is reduced to be almost negligible.

The first internal cavity 20 is provided as a space for adjusting the oxygen partial pressure in the measurement target gas introduced via the second diffusion control unit 13. The oxygen partial pressure is adjusted through an operation of a main pump cell 21.

The main pump cell 21 is an electro-chemical pump cell constituted by an internal pump electrode 22 having a ceiling electrode portion 22a provided over substantially the entire lower face of the second solid electrolyte layer 6 that faces the first internal cavity 20, an external pump electrode 23 provided so as to be exposed to the external space in the region corresponding to the ceiling electrode portion 22a on the upper face of the second solid electrolyte layer 6, and the second solid electrolyte layer 6 held between these electrodes.

The internal pump electrode 22 is formed across upper and lower solid electrolyte layers (the second solid electrolyte layer 6 and the first solid electrolyte layer 4) that define the first internal cavity 20, and the spacer layer 5 that forms side walls. Specifically, the ceiling electrode portion 22a is formed on the lower face of the second solid electrolyte layer 6 that forms the ceiling face of the first internal cavity 20, a bottom electrode portion 22b is formed on the upper face of the first solid electrolyte layer 4 that forms the bottom face, and side electrode portions (not shown) that connect the ceiling electrode portion 22a and the bottom electrode portion 22b are formed on side wall faces (inner faces) of the spacer layer 5 that form two side wall portions of the first internal cavity 20, so that the entire structure is arranged in the form of a tunnel at the region in which the side electrode portions are arranged.

Furthermore, the upper portion layer 7 is arranged above the external pump electrode 23. A slit portion 24 that is continuous with the external space is interposed between the external pump electrode 23 and the upper portion layer 7. The slit portion 24 extends from an end to the other end of the sensor element 101 in the direction perpendicular to the section of the diagram. The slit portion 24 is filled with, for example, a porous material such as porous alumina.

The internal pump electrode 22 and the external pump electrode 23 are formed as porous cermet electrodes (e.g., cermet electrodes of Pt and ZrO₂ containing 1% of Au). Note that the internal pump electrode 22 with which the measurement target gas is brought into contact is made of a material that has a lowered capability of reducing a nitrogen oxide (NOx) component in the measurement target gas.

The main pump cell 21 can apply a desired pump voltage Vp0 to a point between the internal pump electrode 22 and the external pump electrode 23, thereby causing a pump current Ip0 to flow in the positive direction or the negative direction between the internal pump electrode 22 and the external pump electrode 23, so that oxygen in the first internal cavity 20 is pumped out to the external space or oxygen in the external space is pumped into the first internal cavity 20.

Furthermore, in order to detect the oxygen concentration (oxygen partial pressure) in the atmosphere in the first internal cavity 20, the internal pump electrode 22, the second solid electrolyte layer 6, the spacer layer 5, the first solid electrolyte layer 4, the third substrate layer 3, and the reference electrode 42 constitute an electro-chemical sensor cell, that is, a main pump-controlling oxygen partial pressure detection sensor cell 80.

It is possible to see the oxygen concentration (oxygen partial pressure) in the first internal cavity 20 by measuring an electromotive force V0 in the main pump-controlling oxygen partial pressure detection sensor cell 80. Furthermore, the pump current Ip0 is controlled by performing feedback control on Vp0 such that the electromotive force V0 is kept constant. Accordingly, the oxygen concentration in the first internal cavity 20 can be kept at a predetermined constant value.

The third diffusion control unit 30 is a region that applies a predetermined diffusion resistance to the measurement target gas whose oxygen concentration (oxygen partial pressure) has been controlled through an operation of the main pump cell 21 in the first internal cavity 20, thereby guiding the measurement target gas to the second internal cavity 40.

The second internal cavity 40 is provided as a space for performing processing regarding measurement of the concentration of nitrogen oxide in the measurement target gas introduced via the third diffusion control unit 30. The NOx concentration is measured mainly in the second internal cavity 40 whose oxygen concentration has been adjusted by an auxiliary pump cell 50, through an operation of a measurement pump cell 41.

In the second internal cavity 40, the measurement target gas subjected to adjustment of the oxygen concentration (oxygen partial pressure) in advance in the first internal cavity 20 and then introduced via the third diffusion control unit is further subjected to adjustment of the oxygen partial pressure by the auxiliary pump cell 50. Accordingly, the oxygen concentration in the second internal cavity 40 can be precisely kept at a constant value, and thus the gas sensor 100 can measure the NOx concentration with a high level of precision.

The auxiliary pump cell 50 is an auxiliary electro-chemical pump cell constituted by an auxiliary pump electrode 51 having a ceiling electrode portion 51a provided on substantially the entire lower face of the second solid electrolyte layer 6 that faces the second internal cavity 40, the external pump electrode 23 (which is not limited to the external pump electrode 23, and may be any appropriate electrode outside the sensor element 101), and the second solid electrolyte layer 6.

The auxiliary pump electrode 51 with this configuration is arranged inside the second internal cavity 40 in the form of a tunnel as with the above-described internal pump electrode 22 arranged inside the first internal cavity 20. That is to say, the ceiling electrode portion 51a is formed on the second solid electrolyte layer 6 that forms the ceiling face of the second internal cavity 40, a bottom electrode portion 51b is formed on the first solid electrolyte layer 4 that forms the bottom face of the second internal cavity 40, and side electrode portions (not shown) that connect the ceiling electrode portion 51a and the bottom electrode portion 51b are formed on two wall faces of the spacer layer 5 that form side walls of the second internal cavity 40, so that the entire structure is arranged in the form of a tunnel.

Note that the auxiliary pump electrode 51 is also made of a material that has a lowered capability of reducing a nitrogen oxide component in the measurement target gas, as with the internal pump electrode 22.

The auxiliary pump cell 50 can apply a desired voltage Vp1 to a point between the auxiliary pump electrode 51 and the external pump electrode 23, so that oxygen in the atmosphere in the second internal cavity 40 is pumped out to the external space or oxygen in the external space is pumped into the second internal cavity 40.

Furthermore, in order to control the oxygen partial pressure in the atmosphere in the second internal cavity 40, the auxiliary pump electrode 51, the reference electrode 42, the second solid electrolyte layer 6, the spacer layer 5, the first solid electrolyte layer 4, and the third substrate layer 3 constitute an electro-chemical sensor cell, that is, an auxiliary pump-controlling oxygen partial pressure detection sensor cell 81.

Note that the auxiliary pump cell 50 performs pumping using a variable power source 52 whose voltage is controlled based on an electromotive force V1 detected by the auxiliary pump-controlling oxygen partial pressure detection sensor cell 81. Accordingly, the oxygen partial pressure in the atmosphere in the second internal cavity 40 is controlled to be a partial pressure that is low enough to not substantially affect the NOx measurement.

Furthermore, a pump current Ip1 is used to control the electromotive force of the main pump-controlling oxygen partial pressure detection sensor cell 80. Specifically, the pump current Ip1 is input as a control signal to the main pump-controlling oxygen partial pressure detection sensor cell 80, and the electromotive force V0 is controlled such that a gradient of the oxygen partial pressure in the measurement target gas that is introduced from the third diffusion control unit 30 into the second internal cavity 40 is always kept constant. When the sensor is used as an NOx sensor, the oxygen concentration in the second internal cavity 40 is kept at a constant value that is about 0.001 ppm through an operation of the main pump cell 21 and the auxiliary pump cell 50.

The measurement pump cell 41 measures the nitrogen oxide concentration in the measurement target gas, in the second internal cavity 40. The measurement pump cell 41 is an electro-chemical pump cell constituted by a measurement electrode 44 spaced away from the third diffusion control unit 30, on the upper face of the first solid electrolyte layer 4 that faces the second internal cavity 40, the external pump electrode 23, the second solid electrolyte layer 6, the spacer layer 5, and the first solid electrolyte layer 4.

The measurement electrode 44 is a porous cermet electrode. The measurement electrode 44 functions also as an NOx reduction catalyst for reducing NOx that is present in the atmosphere in the second internal cavity 40. Furthermore, the measurement electrode 44 is covered by a fourth diffusion control unit 45.

The fourth diffusion control unit 45 is a membrane constituted by a porous member mainly made of alumina (Al₂O₃). The fourth diffusion control unit 45 serves to limit the amount of NOx flowing into the measurement electrode 44, and also functions as a protective membrane of the measurement electrode 44.

The measurement pump cell 41 can pump out oxygen generated through degradation of nitrogen oxide in the atmosphere around the measurement electrode 44, and detect the generated amount as a pump current Ip2.

Furthermore, in order to detect the oxygen partial pressure around the measurement electrode 44, the second solid electrolyte layer 6, the spacer layer 5, the first solid electrolyte layer 4, the third substrate layer 3, the measurement electrode 44, and the reference electrode 42 constitute an electro-chemical sensor cell, that is, a measurement pump-controlling oxygen partial pressure detection sensor cell 82. A variable power source 46 is controlled based on an electromotive force V2 detected by the measurement pump-controlling oxygen partial pressure detection sensor cell 82.

The measurement target gas guided into the second internal cavity 40 passes through the fourth diffusion control unit 45 and reaches the measurement electrode 44 in a state in which the oxygen partial pressure is controlled. Nitrogen oxide in the measurement target gas around the measurement electrode 44 is reduced to generate oxygen (2NO→N₂+O₂). The generated oxygen is pumped by the measurement pump cell 41, and, at that time, a voltage Vp2 of the variable power source is controlled such that a control voltage V2 detected by the measurement pump-controlling oxygen partial pressure detection sensor cell 82 is kept constant. The amount of oxygen generated around the measurement electrode 44 is proportional to the concentration of nitrogen oxide in the measurement target gas, and thus it is possible to calculate the concentration of nitrogen oxide in the measurement target gas, using the pump current Ip2 in the measurement pump cell 41.

Furthermore, if the measurement electrode 44, the first solid electrolyte layer 4, the third substrate layer 3, and the reference electrode 42 are combined to constitute an oxygen partial pressure detection means as an electro-chemical sensor cell, it is possible to detect an electromotive force that corresponds to a difference between the amount of oxygen generated through reduction of an NOx component in the atmosphere around the measurement electrode 44 and the amount of oxygen contained in reference air can be detected, and thus it is also possible to obtain the concentration of the nitrogen oxide component in the measurement target gas.

Furthermore, the second solid electrolyte layer 6, the spacer layer 5, the first solid electrolyte layer 4, the third substrate layer 3, the external pump electrode 23, and the reference electrode 42 constitute an electro-chemical sensor cell 83, and it is possible to detect the oxygen partial pressure in the measurement target gas outside the sensor, based on an electromotive force Vref obtained by the sensor cell 83.

In the gas sensor 100 with this configuration, when the main pump cell 21 and the auxiliary pump cell 50 operate, the measurement target gas whose oxygen partial pressure is always kept at a constant low value (a value that does not substantially affect the NOx measurement) is supplied to the measurement pump cell 41. Accordingly, it is possible to see the nitrogen oxide concentration in the measurement target gas, based on the pump current Ip2 that flows when oxygen generated through reduction of NOx is pumped out by the measurement pump cell 41, substantially in proportion to the concentration of nitrogen oxide in the measurement target gas.

Furthermore, in order to improve the oxygen ion conductivity of the solid electrolyte, the sensor element 101 includes a heater unit 70 that serves to adjust the temperature of the sensor element 101 through heating and heat retention. The heater unit 70 includes a heater electrode 71, a heater 72, a through-hole 73, a heater insulating layer 74, and a pressure dispersing hole 75. The heater unit 70 is arranged closer to the lower face of the sensor element 101 than to the upper face of the sensor element 101 in the thickness direction of the sensor element 101. Note that the upper face of the sensor element 101 is the upper face of the upper portion layer 7, and the lower face of the sensor element 101 is the lower face of the first substrate layer 1.

The heater electrode 71 is an electrode formed so as to be in contact with the lower face of the first substrate layer 1. When the heater electrode 71 is connected to an external power source, electricity can be supplied from the outside to the heater unit 70.

The heater 72 is an electrical resistor formed so as to be held between the second substrate layer 2 and the third substrate layer 3 from above and below. The heater 72 is connected via the through-hole 73 to the heater electrode 71, and, when electricity is supplied from the outside via the heater electrode 71, the heater 72 generates heat, thereby heating and keeping the temperature of a solid electrolyte constituting the sensor element 101.

Furthermore, the heater 72 is embedded over the entire region from the first internal cavity 20 to the second internal cavity 40, and thus the entire sensor element 101 can be adjusted to a temperature at which the above-described solid electrolyte is activated.

The heater insulating layer 74 is an insulating layer constituted by an insulating member made of alumina or the like on the upper and lower faces of the heater 72. The heater insulating layer 74 is formed in order to realize the electrical insulation between the second substrate layer 2 and the heater 72 and the electrical insulation between the third substrate layer 3 and the heater 72.

The pressure dispersing hole 75 is a hole that extends through the third substrate layer 3 and is connected to the reference gas introduction space 43, and is formed in order to alleviate an increase in the internal pressure in accordance with an increase in the temperature in the heater insulating layer 74.

### 2. Problem Caused by Immediate Start of Gas Sensor

The gas sensor 100 is attached to, for example, an exhaust pipe of an engine of a vehicle. Recently, it is required to start the gas sensor 100 soon after an engine is started. That is to say, it is required to bring forward the time to increase the temperature of the sensor element 101, and to rapidly increase the temperature of the sensor element 101, after an engine is started.

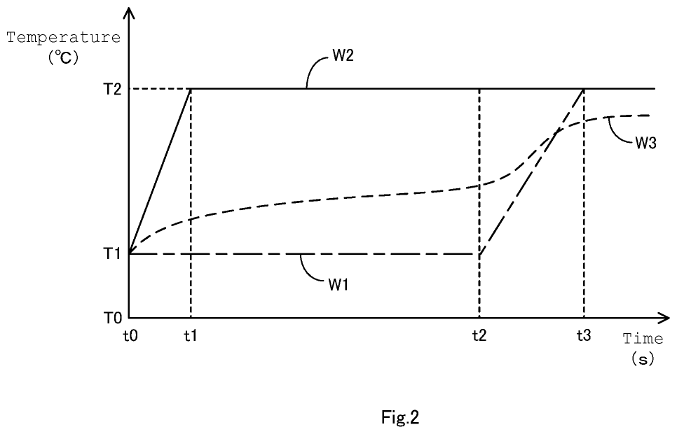

FIG. 2 is a graph showing an example of the way the temperatures of the sensor element 101 and the like change. Referring to FIG. 2, the horizontal axis indicates the time, and the vertical axis indicates the temperature. A line W2 shows an example of a change in the temperature of the sensor element 101, and a line W1 shows an example of a change in the temperature of a comparative sensor element. A line W3 shows an example of a change in the temperature of exhaust gas that passes through an exhaust pipe of an engine.

At time t0, an engine is started. At the time t0, there is condensate water in the exhaust pipe. After the engine is started, the condensate water is scattered in the exhaust pipe and enters the gas sensor 100. In accordance with an increase in the temperature of exhaust gas, for example, at time t2, the inside of the gas sensor 100 enters a dried state.

An increase in the temperature of the comparative sensor element starts after the inside of the gas sensor 100 enters a dried state (time t2). Subsequently, the temperature of the comparative sensor element reaches a temperature T2 at time t3. The temperature T2 is a temperature that is necessary for a gas sensor to function. An increase in the temperature of the comparative sensor element starts after the inside of the gas sensor 100 enters a dried state, and the increase in the temperature is slow, and thus the comparative sensor element is unlikely to crack. However, the comparative sensor element cannot function until the time t3.

On the other hand, an increase in the temperature of the sensor element 101 starts, for example, at the same time as the start of the engine (time t0). The temperature of the sensor element 101 reaches the temperature T2 at time t1. The time taken from the time t0 to the time t1 is shorter than that from time t2 to time t3. That is to say, the time to increase the temperature of the sensor element 101 is earlier than the time to increase the temperature of the comparative sensor element, and the temperature of the sensor element 101 more rapidly increases than that of the comparative sensor element.

In the case in which an increase in the temperature of the sensor element 101 starts at the time t0, condensate water may be attached to the sensor element 101 with an increased temperature. If an increase in the temperature of a sensor element whose structure has not been particularly refined is started at the time t0, thermal stress generated by attachment of condensate water to the sensor element may cause a crack in the sensor element.

Furthermore, if the temperature of a sensor element whose structure has not been particularly refined is rapidly increased to the temperature T2 in a short time from the time t0 to the time t1, thermal stress resulting from a prompt increase in the temperature may cause a crack in the sensor element.

In the gas sensor 100 according to this embodiment, the structure of the sensor element 101 has been refined. As a result, the sensor element 101 is unlikely to crack even when the gas sensor 100 is started soon after an engine is started. Hereinafter, refinements in the structure of the sensor element 101 will be described in detail.

### 3. Characteristic Structure of Gas Sensor

### 3-1. Positions of Internal Cavities in Thickness Direction

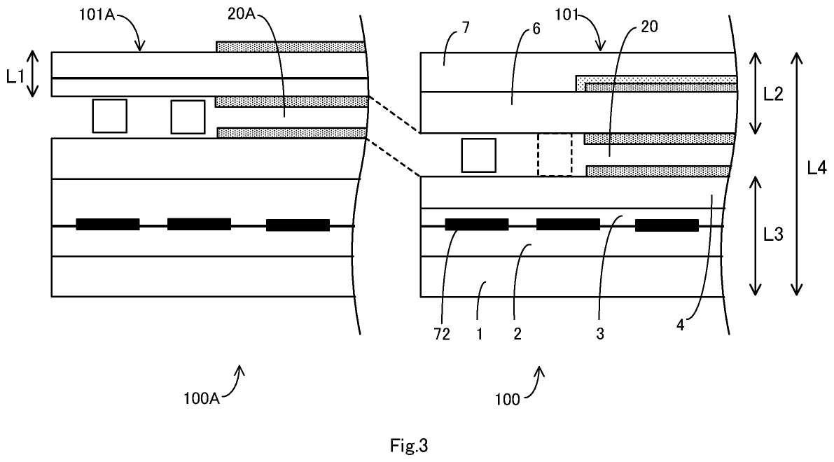

FIG. 3 is a view including a schematic view showing part of a cross-section of the gas sensor 100 according to this embodiment and a schematic view showing part of a cross-section of a comparative gas sensor 100A. Referring to FIG. 3, the part of the cross-section of the gas sensor 100 according to this embodiment is shown on the right side, and the part of the cross-section of the comparative gas sensor 100A is shown on left side.

In the gas sensor 100A, a first internal cavity 20A is arranged closer to the upper face of a sensor element 101A. As a result, a length L1 from the upper face of the sensor element 101A to the upper end of the first internal cavity 20A is short. Since the length L1 is short, when condensate water is attached to the sensor element 101A during an increase in the temperature of the sensor element 101A, a crack may occur at a position near the upper face of the sensor element 101A.

On the other hand, in the gas sensor 100 according to this embodiment, the first internal cavity 20 is formed at a position closer to the center of the sensor element 101 in the thickness direction of the sensor element 101, than that in the comparative gas sensor 100A. Since the first internal cavity 20 is formed at a position close to the center of the sensor element 101, a length L2 from the upper face of the sensor element 101 to the upper end of the first internal cavity 20 and a length L3 from the lower end of the first internal cavity 20 to the lower face of the sensor element 101 are both long to some extent. Since the length L2 and the length L3 are both long to some extent, the rigidity of each of the upper face side and the lower face side of the sensor element 101 is high to some extent. As a result, even when condensate water is attached to the sensor element 101 during an increase in the temperature of the sensor element 101, the sensor element 101 is unlikely to crack.

That is to say, the inventor(s) of the present invention found that a crack in the sensor element 101 particularly resulting from attachment of condensate water can be suppressed by arranging the position of the first internal cavity 20 close to the center in the thickness direction of the sensor element 101. In the gas sensor 100 according to this embodiment, a proportion (L3/L4) of a length (L3) from the end portion of the first internal cavity 20 near the lower face of the sensor element 101 to the lower face of the sensor element 101, to a thickness (L4) of the sensor element 101, is 0.50 or more and 0.65 or less. Thus, according to the gas sensor 100, since the position of the first internal cavity 20 is close to the center to some extent in the thickness direction of the sensor element 101, a crack in the sensor element 101 resulting from attachment of condensate water can be suppressed.

### 3-2. Length of First Internal Cavity in Short Side Direction

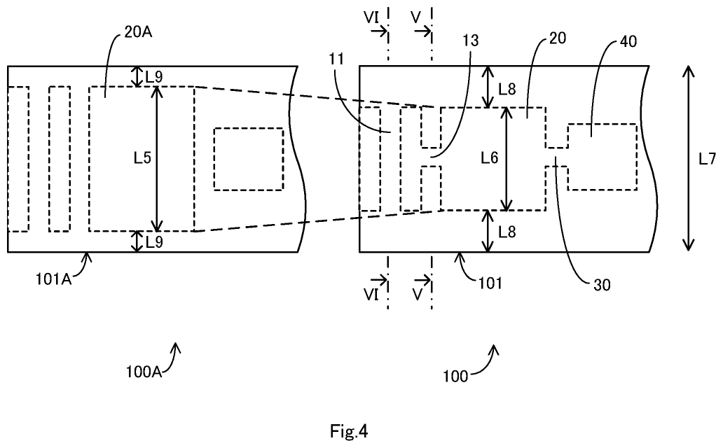

FIG. 4 is a view including a schematic view showing part of a plane of the gas sensor 100 according to this embodiment and a schematic view showing part of a plane of the comparative gas sensor 100A. Referring to FIG. 4, the part of the plane of the gas sensor 100 according to this embodiment is shown on the right side, and the part of the plane of the comparative gas sensor 100A is shown on left side.

The sensor element 101 and the sensor element 101A each have a long side and a short side in a plan view. In the sensor element 101A, a length L5 of the first internal cavity 20A in the short side direction is comparatively long. As a result, a length L9 of a portion that forms side walls of the first internal cavity 20A (a portion that is shortest in the short side direction out of portions in which the first internal cavity 20A is not formed) is short. Since the length L9 is short, when the temperature of the sensor element 101A rapidly increases, side wall portions of the first internal cavity 20A may be cracked.

On the other hand, in the sensor element 101 included in the gas sensor 100 according to this embodiment, the length of the first internal cavity 20 in in the short side direction of the sensor element 101 is shorter than that in the comparative sensor element 101A. As a result, a length L8 of a portion that forms side walls of the first internal cavity 20 (a portion that is shortest in the short side direction out of portions in which the first internal cavity 20 and the second internal cavity 40 are not formed) is long. Since the length L8 is long to some extent, the rigidity of the side walls of the first internal cavity 20 is high to some extent. As a result, even when the temperature of the sensor element 101 rapidly increases, the sensor element 101 is unlikely to crack.

That is to say, the inventor(s) of the present invention found that a crack in the sensor element 101 particularly resulting from a prompt increase in the temperature can be suppressed by ensuring to some extent a length (L8) of a portion that is shortest in the short side direction out of portions in which the first internal cavity 20 and the second internal cavity 40 are not formed in the sensor element 101. In the gas sensor 100, a proportion (L8/L7) of a length (L8) in the short side direction of a portion that is shortest in the short side direction, out of portions in which the first internal cavity 20 and the second internal cavity 40 are not formed, to a length (L7) of the short side of the sensor element 101 is 0.22 or more. Thus, according to the gas sensor 100, since the length in the short side direction of the portion that is shortest in the short side direction out of portions in which the first internal cavity 20 and the second internal cavity 40 are not formed is long to some extent, a crack in the sensor element 101 resulting from a prompt increase in the temperature can be suppressed.

In other words, the inventor(s) of the present invention found that a crack in the sensor element 101 particularly resulting from a prompt increase in the temperature can be suppressed by making the length of the first internal cavity 20 in the short side direction of the sensor element 101 short. In the gas sensor 100 according to this embodiment, a proportion (L6/L7) of a length (L6) of the first internal cavity 20 in the short side direction of the sensor element 101 to a length (L7) of the short side of the sensor element 101 is 0.40 or more and 0.55 or less. Thus, according to the gas sensor 100, the length of the first internal cavity 20 in the short side direction of the sensor element 101 is short to some extent, and thus a crack in the sensor element 101 resulting from a prompt increase in the temperature can be suppressed.

### 3-3. Shape of First and Second Diffusion Control Units in Cross-Section in Thickness Direction

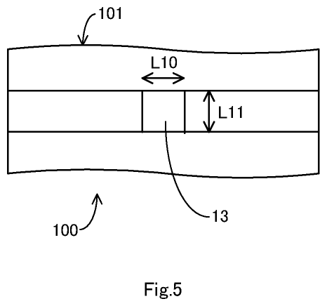

FIG. 5 is a view schematically showing part of a cross-section taken along V-V in FIG. 4. That is to say, FIG. 5 is a view schematically showing part of a cross-section of the sensor element 101 in the thickness direction. In this specification, the “cross-section in the thickness direction” of the sensor element 101 refers to a cross-section obtained when cutting the sensor element 101 in the thickness direction.

Referring to FIGS. 4 and 5, the second diffusion control unit 13 is formed as a hole extending in the long side direction of the sensor element 101. A proportion (L10/L11) of a length (L10) of the second diffusion control unit 13 in the short side direction of the sensor element 101 to a length (L11) of the second diffusion control unit 13 (hole) in the thickness direction of the sensor element 101 is, for example, 0.50 or more and 30.00 or less.

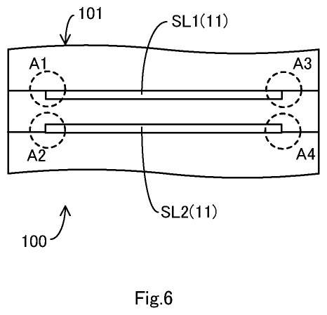

FIG. 6 is a view schematically showing part of a cross-section taken along VI-VI in FIG. 4. Referring to FIGS. 4 and 6, the first diffusion control unit 11 includes two slits SL1 and SL2 that are arranged along the thickness direction of the sensor element 101. In the gas sensor 100, a cross-section in the thickness direction of the first diffusion control unit 11 has such a shape, and thus a decrease in the precision of measurement regarding a predetermined gas component, resulting from a pulsation of the exhaust pressure, can be more efficiently suppressed.

Meanwhile, in the first diffusion control unit 11, the strength of regions A1 and A3 of the slit SL1 and regions A2 and A4 of the slit SL2 is comparatively low. If the shape of a cross-section in the thickness direction of the second diffusion control unit 13 is similar to that of the first diffusion control unit 11, the risk of occurrence of a crack in the sensor element 101 increases.

In the gas sensor 100, the shape of the cross-section in the thickness direction of the first diffusion control unit 11 and the shape of the cross-section in the thickness direction of the second diffusion control unit 13 are different from each other. The rigidity of the second diffusion control unit 13 is higher than that of the first diffusion control unit 11. Thus, in the gas sensor 100, the risk of occurrence of a crack in the sensor element 101 is lowered.

According to the gas sensor 100, since the second diffusion control unit 13 is formed as a hole as described above, the rigidity of the sensor element 101 can be increased, and, furthermore, since the first diffusion control unit 11 includes two slits SL1 and SL2 that are arranged along the thickness direction of the sensor element 101, a decrease in the precision of measurement regarding a predetermined gas component, resulting from a pulsation of the exhaust pressure, can be suppressed. That is to say, according to the gas sensor 100, it is possible to increase the rigidity of the sensor element 101, and also to suppress a decrease in the precision of measurement regarding a predetermined gas component. Note that it is also possible that the shape of the first diffusion control unit 11 and the shape of the second diffusion control unit 13 are switched. That is to say, it is also possible that the first diffusion control unit 11 is formed as a hole as described above, and the second diffusion control unit 13 includes two slits SL1 and SL2 that are arranged along the thickness direction.

### 4. Features

As described above, in the gas sensor 100 according to this embodiment, a proportion of a length in the short side direction of a portion that is shortest in the short side direction, out of portions in which the first internal cavity 20 and the second internal cavity 40 are not formed, to the length of the short side of the sensor element 101 is 0.22 or more. Thus, according to the gas sensor 100, the length in the short side direction of the portion that is shortest in the short side direction out of portions in which the first internal cavity 20 and the second internal cavity 40 are not formed is long to some extent, and thus a crack in the sensor element 101 resulting from a prompt increase in the temperature can be suppressed.

Furthermore, in the gas sensor 100 according to this embodiment, a proportion of the length from the lower end of the first internal cavity 20 to the lower face of the sensor element 101, to the thickness of the sensor element 101, is 0.50 or more and 0.65 or less. Thus, according to the gas sensor 100, since the position of the first internal cavity 20 is close to the center to some extent in the thickness direction of the sensor element 101, a crack in the sensor element 101 resulting from attachment of condensate water can be suppressed. Thus, according to the gas sensor 100, occurrence of a crack in the sensor element 101 can be suppressed even when the gas sensor 100 is started soon after an engine is started.

### 5. Modified Examples

Although an embodiment of the present invention has been described above, the present invention is not limited to the foregoing embodiment, and various modifications can be made within the scope not departing from the gist of the invention. Hereinafter, modified examples will be described.

5-1

In the gas sensor 100 according to the foregoing embodiment, the first internal cavity 20 and the second internal cavity 40 are formed in the sensor element 101. That is to say, the sensor element 101 has a two-cavity structure. However, the sensor element 101 does not absolutely have to have a two-cavity structure. For example, it is also possible that the sensor element 101 has a three-cavity structure.

FIG. 7 is a cross-sectional schematic view schematically showing an example of the configuration of a gas sensor 100X including a sensor element 101X with a three-cavity structure. It is also possible that, as shown in FIG. 7, the second internal cavity 40 (FIG. 1) is further divided by a fifth diffusion control unit 60 into two cavities consisting of a second internal cavity 40X and a third internal cavity 61. In this case, an auxiliary pump electrode 51X may be arranged in the second internal cavity 40X, and a measurement electrode 44X may be arranged in the third internal cavity 61. In the case of applying a three-cavity structure, the fourth diffusion control unit 45 may be omitted.

5-2

Also, in the gas sensor 100 according to the foregoing embodiment, the slit portion 24 is filled with a porous material. However, the slit portion 24 does not absolutely have to be filled with a porous material.

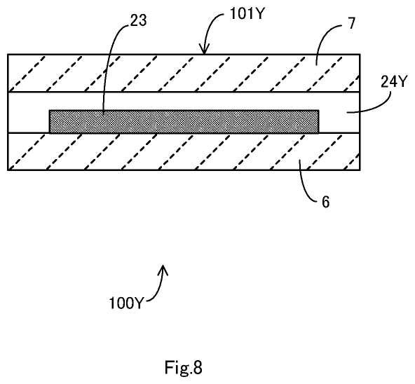

FIG. 8 is a view schematically showing part of a cross-section of a sensor element 101Y in the thickness direction according to a modified example. As shown in FIG. 8, the upper portion layer 7 is arranged above the external pump electrode 23. The slit portion 24Y is interposed between the external pump electrode 23 and the upper portion layer 7. According to the modified example, the slit portion 24Y is hollow. Note that the width of the slit portion 24Y is the same as that of the upper portion layer 7. In this manner, it is also possible that the slit portion 24Y is hollow.

5-3

Also, in the gas sensor 100 according to the foregoing embodiment, the sensor element 101 includes the upper portion layer 7. However, the sensor element 101 does not absolutely have to include the upper portion layer 7. In this case, it is also possible that the slit portion 24 is not formed above the external pump electrode 23, and the upper portion of the external pump electrode 23 is exposed to the outside.

5-4

Also, in the gas sensor 100 according to the foregoing embodiment, the gas flow passage (the region from the gas introduction opening 10 to the second internal cavity 40) is positioned at the center in the short side direction of the sensor element 101. However, the gas flow passage does not absolutely have to be positioned at the center in the short side direction of the sensor element 101.

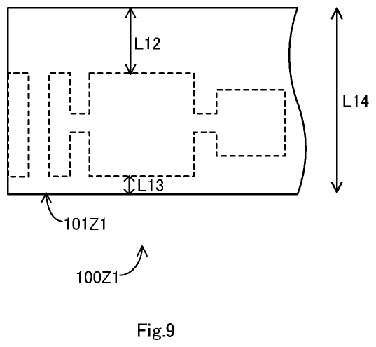

FIG. 9 is a view showing part of a plane of the gas sensor 100Z1 according to a modified example. As shown in FIG. 9, it is also possible that the gas flow passage is formed at a position closer to one side in the short side direction of a sensor element 101Z1. In this case, a length of a portion that is shortest in the short side direction out of portions in which the internal cavity is not formed is L13. That is to say, in this case, a proportion (L13/L14) of the length (L13) in the short side direction of the portion that is shortest in the short side direction, out of portions in which the internal cavity is not formed, to a length (L14) of the short side of the sensor element 101Z1 is 0.22 or more.

5-5

Also, in the gas sensor 100 according to the foregoing embodiment, the first internal cavity 20 is rectangular. However, the first internal cavity 20 does not absolutely have to be rectangular. For example, it is also possible that the first internal cavity 20 is trapezoidal.

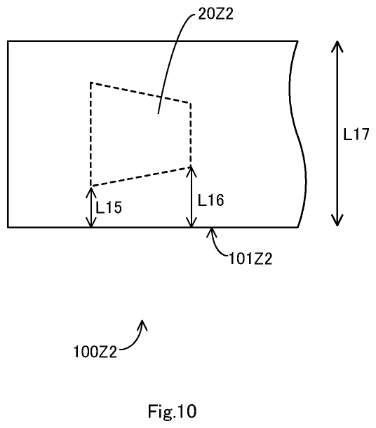

FIG. 10 is a view showing part of a plane of another gas sensor 100Z2 according to a modified example. As shown in FIG. 10, a first internal cavity 20Z2 is trapezoidal. In this case, a length of a portion that is shortest in the short side direction out of portions in which the internal cavity is not formed is L15. That is to say, in this case, a proportion (L15/L17) of the length (L15) in the short side direction of the portion that is shortest in the short side direction, out of portions in which the internal cavity is not formed, to a length (L17) of the short side of a sensor element 101Z2 is 0.22 or more.

### 6. Examples, Etc.

### 6-1. Examples and Comparative Examples

First, a sensor element 101 representing Example 1 was produced using a method, which will be described below.

Seven unfired ceramic green sheets each containing an oxygen ion-conductive solid electrolyte such as zirconia as a ceramic component were prepared. Note that each of the ceramic green sheets was formed through tape casting of a mixture of zirconia particles to which 4 mol % of yttria serving as a stabilizer was added, an organic binder, and an organic solvent. A plurality of sheet holes for use in positioning during printing or stacking, necessary through-holes, and the like were formed through the green sheets.

Furthermore, a space for use as the gas flow passage was formed in advance through punching through a green sheet for use as the spacer layer 5. The second diffusion control unit 13 and the third diffusion control unit 30 were also formed through punching. Then, pattern printing and drying for forming various patterns were performed on the ceramic green sheets respectively corresponding to the first substrate layer 1, the second substrate layer 2, the third substrate layer 3, the first solid electrolyte layer 4, the spacer layer 5, the second solid electrolyte layer 6, and the upper portion layer 7.

Specifically, the formed patterns were patterns of the above-described electrodes, lead wires connected to the electrodes, the air introduction layer 48, the heater unit 70, and the like. The pattern printing was performed by applying a pattern forming paste prepared according to properties required for the respective patterns that were to be formed, to green sheets using a known screen printing technique. The drying was also performed using a known drying means. When the pattern printing and the drying were ended, printing and drying of a bonding paste for stacking and bonding the green sheets corresponding to the respective layers were performed.

Then, the green sheets on which the bonding paste was formed were positioned using the sheet holes and stacked in a predetermined order, and subjected to pressure bonding in which the sheets were pressure-bonded by application of predetermined temperature and pressure conditions, and thus one stack was formed. The thus obtained stack included a plurality of sensor elements 101. The stack was cut into portions each having the size of a sensor element 101. Then, the cut stack was fired at a predetermined firing temperature, and thus a sensor element 101 was obtained.

In Example 1, the thickness of the sensor element 101 was 1550 μm. The length from the lower end of the first internal cavity 20 to the lower face of the sensor element 101 was 900 μm. That is to say, the proportion of the length from the lower end of the first internal cavity 20 to the lower face of the sensor element 101, to the thickness of the sensor element 101, was 0.58. Furthermore, the length of the short side of the sensor element 101 was 4.25 mm. The length of the first internal cavity 20 in the short side direction of the sensor element 101 was 2.00 mm. That is to say, the proportion of the length of the first internal cavity 20 in the short side direction of the sensor element 101 to the length of the short side of the sensor element 101 was 0.47. Furthermore, in the sensor element 101, the length in the short side direction of the portion that was shortest in the short side direction, out of portions in which the internal cavity was not formed, was 1.125 mm. That is to say, the proportion of the length in the short side direction of the portion that was shortest in the short side direction, out of portions in which the internal cavity was not formed, to the length of the short side of the sensor element 101 was about 0.26. Furthermore, the second diffusion control unit 13 was constituted by a hole formed through punching.

Furthermore, a sensor element of Comparative Example 1-3 was produced. The method for producing the sensor element of Comparative Example 1-3 was substantially the same as the method for producing the sensor element 101 of Example 1. The sensor element 101 of Example 1 and the sensor element of Comparative Example 1-3 were different from each other mainly in the position of the first internal cavity in the thickness direction of the sensor element, the width of the first internal cavity (the length in the short side direction of the portion that was shortest in the short side direction, out of portions in which the first internal cavity was not formed), and the shape of the second diffusion control unit.

In Comparative Example 1, the thickness of the sensor element was 1550 μm. The length from the lower end of the first internal cavity to the lower face of the sensor element was 1020 μm. That is to say, the proportion of the length from the lower end of the first internal cavity to the lower face of the sensor element, to the thickness of the sensor element, was 0.66. Furthermore, the length of the short side of the sensor element was 4.25 mm. The length of the first internal cavity in the short side direction of the sensor element was 2.50 mm. That is to say, the proportion of the length of the first internal cavity in the short side direction of the sensor element to the length of the short side of the sensor element was 0.59. Furthermore, in the sensor element, the length in the short side direction of the portion that was shortest in the short side direction, out of portions in which the internal cavity was not formed, was 0.875 mm. That is to say, the proportion of the length in the short side direction of the portion that was shortest in the short side direction, out of portions in which the internal cavity was not formed, to the length of the short side of the sensor element was about 0.21. Furthermore, the second diffusion control unit was constituted by a slit similar to the first diffusion control unit 11.

In Comparative Example 2, the thickness of the sensor element was 1550 μm. The length from the lower end of the first internal cavity to the lower face of the sensor element was 1020 μm. That is to say, the proportion of the length from the lower end of the first internal cavity to the lower face of the sensor element, to the thickness of the sensor element, was 0.66. Furthermore, the length of the short side of the sensor element was 4.25 mm. The length of the first internal cavity in the short side direction of the sensor element was 2.50 mm. That is to say, the proportion of the length of the first internal cavity in the short side direction of the sensor element to the length of the short side of the sensor element was 0.59. Furthermore, in the sensor element, the length in the short side direction of the portion that was shortest in the short side direction, out of portions in which the internal cavity was not formed, was 0.875 mm. That is to say, the proportion of the length in the short side direction of the portion that was shortest in the short side direction, out of portions in which the internal cavity was not formed, to the length of the short side of the sensor element was about 0.21. Furthermore, the second diffusion control unit was constituted by a hole formed through punching.

In Comparative Example 3, the thickness of the sensor element was 1550 μm. The length from the lower end of the first internal cavity to the lower face of the sensor element was 1020 μm. That is to say, the proportion of the length from the lower end of the first internal cavity to the lower face of the sensor element, to the thickness of the sensor element, was 0.66. Furthermore, the length of the short side of the sensor element was 4.25 mm. The length of the first internal cavity in the short side direction of the sensor element was 2.00 mm. That is to say, the proportion of the length of the first internal cavity in the short side direction of the sensor element to the length of the short side of the sensor element was 0.47. Furthermore, in the sensor element, the length in the short side direction of the portion that was shortest in the short side direction, out of portions in which the internal cavity was not formed, was 1.125 mm. That is to say, the proportion of the length in the short side direction of the portion that was shortest in the short side direction, out of portions in which the internal cavity was not formed, to the length of the short side of the sensor element was about 0.26. Furthermore, the second diffusion control unit was constituted by a hole formed through punching.

### 6-2. Water Ingress Resistance Test

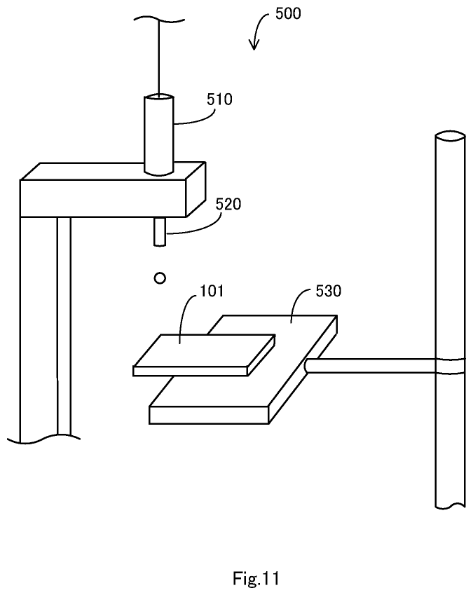

FIG. 11 is a view schematically showing an apparatus for use in a water ingress resistance test. As shown in FIG. 11, a dispenser 500 includes a head 510 and a nozzle 520. The sensor element 101 is held by an element clamp 530.

In the water ingress resistance test, a liquid is supplied from a liquid storage unit to the nozzle 520 with an inner diameter of 3 mm or less. Specifically, the liquid is supplied to the nozzle 520 by application of pressure obtained by adding 1 to 10 kPa to atmospheric pressure. Using the liquid dripping, one droplet in a desired drop amount set to 3 to 70 μL is dropped from the front end of the nozzle 520 onto the sensor element 101. The influence of dropping of a droplet onto the sensor element 101 is evaluated.

More specifically, a droplet is dropped onto a predetermined position of the sensor element 101 by opening the nozzle for a first predetermined period of time. If no abnormality appears in the sensor element 101, a droplet is dropped onto a predetermined position of the sensor element 101 for a second predetermined period of time that is longer than the first predetermined period of time. This processing is repeated until any abnormality appears in the sensor element 101 or until patterns of all predetermined periods of time set in advance are completed.

If the sensor element 101 is cracked by dropping of a droplet, oxygen enters the first internal cavity 20 and Ip0 (FIG. 1) abruptly increases. Whether or not the sensor element 101 is cracked is determined based on whether or not there is an abrupt increase in Ip0. The number of samples in each of Example 1 and Comparative Example 1-3 was 5. The water ingress resistance test was performed using this method.

### 6-3. Rapid Temperature Increase Test

The rapid temperature increase test was performed by increasing the temperature of the heater 72 to a predetermined temperature in 15 seconds, the time taken to increase the temperature of the heater 72 to the predetermined temperature being typically 50 seconds. The temperature of the heater 72 is controlled through a heater resistance. The heater resistance when the gas sensor 100 is driven is obtained by multiplying the heater resistance at room temperature (sample eigenvalue) by a constant. In the rapid temperature increase test, a voltage was applied to the heater unit 70 such that the heater resistance reached the heater resistance at the time of driving in 15 seconds.

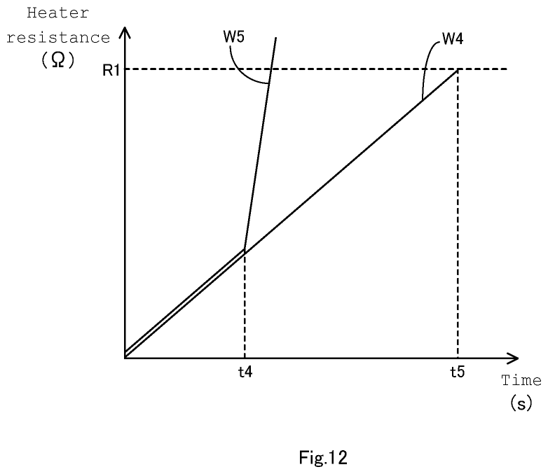

FIG. 12 is a graph showing an example of a change in the heater resistance. Referring to FIG. 12, the horizontal axis indicates the time, and the vertical axis indicates the heater resistance. If the sensor element 101 is not cracked, for example, the heater resistance increases as indicated by the line W4. That is to say, the heater resistance reaches a heater resistance R1 at the time of driving at time t5 (in 15 seconds). On the other hand, if the sensor element 101 is cracked, for example, the heater resistance has an abnormal value as indicated by the line W5. The properties in a rapid temperature increase were evaluated according to the crack occurrence in ten sensor elements.

### 6-4. Test Result

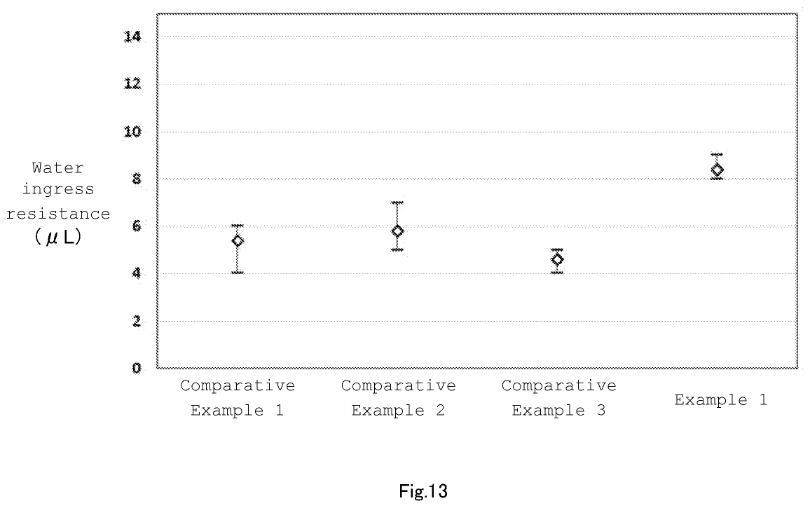

FIG. 13 is a graph showing results of a water ingress resistance test. As shown in FIG. 13, in Comparative Example 1, all samples were cracked by at least 7 μL of liquid. In Comparative Example 2, all samples were cracked by at least 8 μL of liquid. In Comparative Example 3, all samples were cracked by at least 6 μL of liquid. On the other hand, in Example 1, some samples were cracked by 9 μL of liquid, but no sample was cracked by 8 μL of liquid.

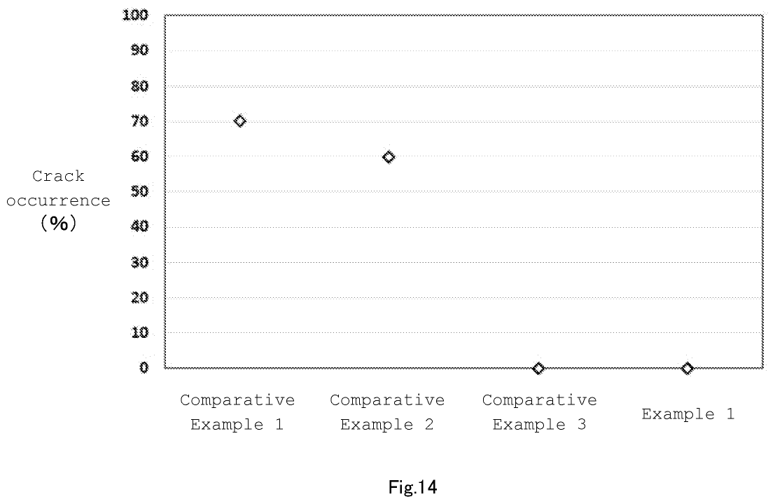

FIG. 14 is a graph showing results of a rapid temperature increase test. As shown in FIG. 14, in Comparative Example 1, 70% of the samples where cracked. In Comparative Example 2, 60% of the samples where cracked. No crack occurred in Comparative Example 3 and Example 1. Contrary to Comparative Example 1-3, Example 1 achieved a high performance in both of the water ingress resistance test and the rapid temperature increase test.

### LIST OF REFERENCE NUMERALS

1 First substrate layer
2 Second substrate layer
3 Third substrate layer
4 First solid electrolyte layer
5 Spacer layer
6 Second solid electrolyte layer
7 Upper portion layer
10 Gas introduction opening
11 First diffusion control unit
12 Buffer space
13 Second diffusion control unit
20, 20A First internal cavity
21 Main pump cell
22 Internal pump electrode
22a, 51a, 51aX Ceiling electrode portion
22b, 51b, 51bX Bottom electrode portion
23 External pump electrode
24, 24Y Slit portion
30 Third diffusion control unit
40, 40X Second internal cavity
41 Measurement pump cell
42 Reference electrode
43 Reference gas introduction space
44, 44X Measurement electrode
45 Fourth diffusion control unit
46, 52 Variable power source
48 Air introduction layer
50 Auxiliary pump cell
51, 51X Auxiliary pump electrode
60 Fifth diffusion control unit
61 Third internal cavity
70 Heater unit
71 Heater electrode
72 Heater
73 Through-hole
74 Heater insulating layer
75 Pressure dispersing hole
80 Main pump-controlling oxygen partial pressure detection sensor cell
81 Auxiliary pump-controlling oxygen partial pressure detection sensor cell
82 Measurement pump-controlling oxygen partial pressure detection sensor cell
83 Sensor cell
100, 100A Gas sensor
101 Sensor element
500 Dispenser
510 Head
520 Nozzle
530 Element clamp
A1, A2, A3, A4 Region
W1, W2, W3, W4, W5 Line

What is claimed is:

1. A gas sensor configured to measure a concentration of a predetermined gas component in a measurement target gas, comprising:
a sensor element,
wherein the sensor element includes an oxygen ion-conductive solid electrolyte,
an internal cavity configured to introduce the measurement target gas from an external space is formed inside the sensor element,
the sensor element includes an oxygen pumping cell,
the oxygen pumping cell includes:
an internal pump electrode formed inside the internal cavity; and
an external pump electrode formed in a space different from the internal cavity,
the oxygen pumping cell is configured to pump out oxygen in the internal cavity, by applying a voltage to a point between the internal pump electrode and the external pump electrode,
the sensor element has a long side and a short side in a plan view,
in the sensor element, a proportion of a length in the short side direction of a portion that is shortest in the short side direction, out of portions in which the internal cavity is not formed, to a length of the short side is 0.22 or more,
the sensor element has an upper face and a lower face, and
a proportion of a length from the end portion of the internal cavity near the lower face to the lower face, to a thickness of the sensor element, is 0.50 or more and 0.65 or less.

2. The gas sensor according to claim 1, wherein a proportion of a length in the short side direction of the internal cavity to the length of the short side is 0.40 or more and 0.58 or less.

3. The gas sensor according to claim 1,
wherein the sensor element further includes a heat generating unit configured to generate heat, and
the heat generating unit is arranged closer to the lower face than to the upper face in the thickness direction of the sensor element.

4. The gas sensor according to claim 1,
wherein a diffusion control unit is further formed inside the sensor element,
the diffusion control unit is configured to apply a predetermined diffusion resistance to the measurement target gas introduced from the external space via a gas introduction opening,
the diffusion control unit includes a hole that extends in the long side direction and connects the gas introduction opening and the internal cavity, and
a proportion of a length in the short side direction of the hole to a length in the thickness direction of the hole is 0.50 or more and 30.00 or less.

5. The gas sensor according to claim 4,
wherein the diffusion control unit includes a first diffusion control unit and a second diffusion control unit,
the first and second diffusion control units are arranged along the long side direction, and
a cross-sectional shape in the thickness direction of the first diffusion control unit and a cross-sectional shape in the thickness direction of the second diffusion control unit are different from each other.

6. The gas sensor according to claim 5,
wherein one of the first and second diffusion control units includes the hole, and
the other of the first and second diffusion control units includes two slits that are arranged along the thickness direction.

7. The gas sensor according to claim 1,
wherein the sensor element is a stack of a plurality of ceramic layers,
the external pump electrode is covered by any one of the plurality of ceramic layers in the sensor element, and
a slit portion that is continuous with the external space is formed between the ceramic layer covering the external pump electrode and the external pump electrode.
